(19) United States
(12) Patent Application Publication
(10) Pub. No.: US 2022/0255240 A1
(43) Pub. Date: Aug. 11, 2022

(54) ANTENNA MODULE AND ELECTRONIC DEVICE

(71) Applicant: GUANGDONG OPPO MOBILE TELECOMMUNICATIONS CORP., LTD., Dongguan (CN)

(72) Inventor: Yuhu Jia, Dongguan (CN)

(21) Appl. No.: 17/733,979

(22) Filed: Apr. 29, 2022

Related U.S. Application Data
(63) Continuation of application No. PCT/CN2020/121905, filed on Oct. 19, 2020.

(30) Foreign Application Priority Data
Oct. 31, 2019 (CN) 201911053843.7
Jan. 17, 2020 (CN) 202010054999.3
Jan. 17, 2020 (CN) 202020124000.3

(51) Int. Cl. H01Q 21/30; H01Q 21/06; H01Q 1/44; H01Q 1/24

(52) U.S. Cl. CPC H01Q 21/30; H01Q 1/24; H01Q 1/44; H01Q 21/065

(57) ABSTRACT

An antenna module and an electronic device are provided. The antenna module includes a dielectric substrate, a patch array, a grounding layer, a grounding portion, and a feeding portion. The patch array is carried on a first surface of the dielectric substrate and defines a first slot and a second slot intersected with the first slot. The grounding layer is carried on a second surface of the dielectric substrate. The second surface is opposite to the first surface. The grounding portion is electrically connected with the patch array and the grounding layer. The feeding portion includes a first feeding member and a second feeding member disposed in an intersected and insulated manner. The first feeding member and second feeding member are respectively configured to feed current signals, to excite the patch array and grounding portion to resonate in corresponding frequency bands.

### CROSS-REFERENCE TO RELATED APPLICATION(S)

This application is a continuation application of International Application No. PCT/CN2020/121905, filed on Oct. 19, 2020, which claims priority to Chinese Patent Application No. 201911053843.7 filed on Oct. 31, 2019, Chinese Patent Application No. 202010054999.3 filed on Jan. 17, 2020, and Chinese Patent Application No. 202020124000.3 filed on Jan. 17, 2020, the entire disclosures of all of which are incorporated herein by reference.

### TECHNICAL FIELD

This disclosure relates to the technical field of electronics, and in particular to an antenna module and an electronic device.

### BACKGROUND

Millimeter wave (mmWave) has characteristics of high carrier frequency and large bandwidth, and is a main means to realize ultra-high data transmission rate of the fifth generation (5G) mobile communication technology. Due to intense space losses of electromagnetic waves in a mmWave frequency band, a wireless communication system using the mmWave frequency band needs a framework using a phased array. Phases of each array element are distributed according to a certain rule through a phase shifter, so as to form a beam with a high gain, and the beam is scanned within a certain spatial range by changing phase shift.

### SUMMARY

An antenna module is provided in the present disclosure. The antenna module includes a dielectric substrate, a patch array, a grounding layer, a grounding portion, and a feeding portion. The patch array is carried on a first surface of the dielectric substrate, where the patch array defines a first slot and a second slot intersected with the first slot. The grounding layer carried on a second surface of the dielectric substrate, where the second surface is opposite to the first surface. The grounding portion is electrically connected with the patch array and the grounding layer. The feeding portion includes a first feeding member and a second feeding member insulated from the first feeding member, where a projection of the first feeding member on the dielectric substrate is intersected with a projection of the second feeding member on the dielectric substrate, the projection of the first feeding member on the dielectric substrate and a projection of the first slot on the dielectric substrate are at least partially overlapped, the projection of the second feeding member on the dielectric substrate and a projection of the second slot on the dielectric substrate are at least partially overlapped, and the first feeding member and the second feeding member are respectively configured to feed current signals, to excite the patch array and the grounding portion to resonate in corresponding frequency bands.

An electronic device is also provided in implementations of the present disclosure. The electronic device includes a main board and the antenna module which is provided in any of the above implementations. The antenna module is electrically connected with the main board, and the antenna module is configured to receive and transmit a radio frequency (RF) signal under control of the main board.

### BRIEF DESCRIPTION OF DRAWINGS

In order to describe technical solutions of implementations of the present disclosure more clearly, the following will give a brief introduction to the accompanying drawings used for describing the implementations. Apparently, the accompanying drawings hereinafter described are some implementations of the present disclosure. Based on these drawings, those of ordinary skill in the art can also obtain other drawings without creative effort.

FIG. 1 is a schematic structural view illustrating an antenna module provided in implementations.

FIG. 2 is a partial schematic structural view illustrating the antenna module provided in FIG. 1.

FIG. 3 is a schematic structural view illustrating the antenna module provided in FIG. 2, taken on XY-plane.

FIG. 4 is a schematic structural view illustrating the antenna module provided in FIG. 2, taken on YZ-plane.

FIG. 5 is a schematic structural view illustrating an antenna module provided in implementations of the present disclosure, taken on XY-plane.

FIG. 6 is a schematic structural view illustrating a radiator of an antenna module provided in implementations of the present disclosure.

FIG. 7 is a schematic structural view illustrating a radiator of an antenna module provided in other implementations of the present disclosure.

FIG. 8 is a schematic structural view illustrating a grounding portion of an antenna module provided in implementations of the present disclosure.

FIG. 9 is a schematic structural view illustrating a grounding portion of an antenna module provided in other implementations of the present disclosure.

FIG. 10 is a schematic structural view illustrating a grounding portion of an antenna module provided in other implementations of the present disclosure.

FIG. 11 is a schematic structural view illustrating a feeding portion of an antenna module provided in other implementations of the present disclosure.

FIG. 12 is a schematic structural view illustrating the feeding portion of the antenna module provided in FIG. 11, taken on YZ-plane.

FIG. 13 is another schematic structural view illustrating the feeding portion of the antenna module provided in FIG. 11, taken on YZ-plane.

FIG. 14 is a schematic cross-sectional structural view illustrating an electronic device provided in implementations of the present disclosure.

FIG. 15 is a schematic cross-sectional structural view illustrating an electronic device provided in other implementations of the present disclosure.

FIG. 16 is a schematic cross-sectional structural view illustrating an electronic device provided in other implementations of the present disclosure.

FIG. 17 is a schematic cross-sectional structural view illustrating an electronic device provided in other implementations of the present disclosure.

FIG. 18 is a schematic cross-sectional structural view illustrating an electronic device provided in other implementations of the present disclosure.

FIG. 19 is a schematic structural view illustrating a return loss curve of each port of a 1×4 antenna array.

FIG. 20 is a schematic view illustrating isolation curves between patch-unit ports of a 1×4 antenna array.

FIG. 21 is a radiation gain pattern illustrating an antenna module in a V-polarization direction in a frequency band of 24.25 gigahertz (GHz).

FIG. 22 is a radiation gain pattern illustrating an antenna module in a V-polarization direction in a frequency band of 26 GHz.

FIG. 23 is a radiation gain pattern illustrating an antenna module in a V-polarization direction in a frequency band of 28 GHz.

FIG. 24 is a radiation gain pattern illustrating an antenna module in a V-polarization direction in a frequency band of 29.5 GHz.

FIG. 25 is a radiation gain pattern illustrating an antenna module in a V-polarization direction in a frequency band of 37 GHz.

FIG. 26 is a radiation gain pattern illustrating an antenna module in a V-polarization direction in a frequency band of 39 GHz.

FIG. 27 is a radiation gain pattern illustrating an antenna module in a H-polarization direction in a frequency band of 24.25 GHz.

FIG. 28 is a radiation gain pattern illustrating an antenna module in a H-polarization direction in a frequency band of 26 GHz.

FIG. 29 is a radiation gain pattern illustrating an antenna module in a H-polarization direction in a frequency band of 28 GHz.

FIG. 30 is a radiation gain pattern illustrating an antenna module in a H-polarization direction in a frequency band of 29.5 GHz.

FIG. 31 is a radiation gain pattern illustrating an antenna module in a H-polarization direction in a frequency band of 37 GHz.

FIG. 32 is a radiation gain pattern illustrating an antenna module in a H-polarization direction in a frequency band of 39 GHz.

FIG. 33 is a schematic view illustrating variation curves of peak gains of an antenna module in different polarization directions with frequencies.

### DETAILED DESCRIPTION

An antenna module is provided in the present disclosure. The antenna module includes dielectric substrate, a patch array, a grounding layer, a grounding portion, and a feeding portion. The patch array is carried on a first surface of the dielectric substrate, where the patch array defines a first slot and a second slot intersected with the first slot. The grounding layer carried on a second surface of the dielectric substrate, where the second surface is opposite to the first surface. The grounding portion is electrically connected with the patch array and the grounding layer. The feeding portion includes a first feeding member and a second feeding member insulated from the first feeding member, where a projection of the first feeding member on the dielectric substrate is intersected with a projection of the second feeding member on the dielectric substrate, the projection of the first feeding member on the dielectric substrate and a projection of the first slot on the dielectric substrate are at least partially overlapped, the projection of the second feeding member on the dielectric substrate and a projection of the second slot on the dielectric substrate are at least partially overlapped, and the first feeding member and the second feeding member are respectively configured to feed current signals, to excite the patch array and the grounding portion to resonate in corresponding frequency bands.

In an implementation, the first feeding member is configured to feed a first current signal, the first current signal is coupled to the patch array to excite the patch array to resonate in a first frequency band, and the first current signal is coupled to the grounding portion to excite the grounding portion to resonate in a second frequency band, where the first frequency band is different from the second frequency band. The second feeding member is configured to feed a second current signal, the second current signal is coupled to the patch array to excite the patch array to resonate in a third frequency band, and the second current signal is coupled to the grounding portion to excite the grounding portion to resonate in a fourth frequency band, where the third frequency band is different from the fourth frequency band.

In an implementation, a minimum value of the first frequency band is greater than a maximum value of the second frequency band, a minimum value of the third frequency band is greater than a maximum value of the fourth frequency band, and the first frequency band, the second frequency band, the third frequency band, and the fourth frequency band together constitute a preset frequency band, where the preset frequency band at least includes a full frequency band of 3rd generation partnership project (3GPP) millimeter wave (mmWave).

In an implementation, the antenna module includes a first feeding port and a second feeding port. The first feeding member has a first section and a second section connected with the first section, a first included angle is defined between the first section and the second section, the first section is electrically connected with the first feeding port, the first section is disposed close to the grounding portion, and the second section is disposed close to the patch array. The second feeding member has a third section and a fourth section connected with the third section, a second included angle is defined between the third section and the fourth section, the third section is electrically connected with the second feeding port, the third section is disposed close to the grounding portion, and the fourth section is disposed close to the patch array. The second section keeps orthogonal to the fourth section, and a polarization direction of the patch array keeps orthogonal to a polarization direction of the grounding portion.

In an implementation, the first section is perpendicular to the grounding layer, the third section is perpendicular to the grounding layer, the first section keeps perpendicular to the second section, and the third section keeps perpendicular to the fourth section.

In an implementation, the second section and the fourth section are located on different layers respectively, and the second section is spaced apart from the fourth section.

In an implementation, the second section has a first connection portion, a bending portion, and a second connection portion which are connected in sequence, the first connection portion is connected with the first section, the first connection portion, the second connection portion, and the fourth section are disposed on the same layer, and the bending portion avoids the fourth section.

In an implementation, the patch array and any one of the second section and the fourth section are disposed on the same layer.

In an implementation, the patch array includes a first radiator and a second radiator spaced apart from the first radiator. The grounding portion includes a first grounding member and a second grounding member, the first grounding member is electrically connected with the first radiator and the grounding layer, and the second grounding member is electrically connected with the first radiator and the grounding layer. The grounding portion further includes a third grounding member and a fourth grounding member, the third grounding member is electrically connected with the second radiator and the grounding layer, and the fourth grounding member is electrically connected with the second radiator and the grounding layer.

In an implementation, the first grounding member is connected with the second grounding member and the first grounding member and the second grounding member at least share a partial structure, or the first grounding member is spaced apart from the second grounding member. The third grounding member is connected with the fourth grounding member and the third grounding member and the fourth grounding member at least share a partial structure, or the third grounding member is spaced apart from the fourth grounding member.

In an implementation, the patch array further includes a third radiator and a fourth radiator, the first radiator, the second radiator, the third radiator, and the fourth radiator are all spaced apart to define a first slot and a second slot intersected with each another.

In an implementation, each of the first radiator, the second radiator, the third radiator, and the fourth radiator is a metal patch, and the patch array has a mirror symmetric structure.

In an implementation, the first radiator defines multiple first metallization via holes arranged in an array at an edge part of the first radiator close to the first feeding member and the second feeding member, and the second radiator defines multiple second metallization via holes arranged in an array at an edge part of the second radiator close to the first feeding member and the second feeding member.

In an implementation, the first radiator defines a first accommodating groove at an edge part of the first radiator away from the second feeding member, the second radiator defines a second accommodating groove at an edge part of the second radiator away from the second feeding member, and an opening direction of the first accommodating groove is opposite to an opening direction of the second accommodating groove.

In an implementation, the first radiator defines a first curved groove at a middle part of the first radiator away from the first feeding member, and the second radiator defines a second curved groove at a middle part of the second radiator away from the second feeding member, and an opening direction of the first curved groove is opposite to an opening direction of the second curved groove.

In an implementation, the grounding portion has a first part, a second part, a third part, a fourth part, and fifth part. The first part, the second part, and the third part are connected in sequence, a first included angle is defined between the first part and the second part, and a second included angle is defined between the second part and the third part. The first part, the fourth part, and the fifth part are connected in sequence, a third included angle is defined between the first part and the fourth part, and a fourth included angle is defined between the fourth part and the fifth part. The first part is electrically connected with the patch array, the third part is electrically connected with the grounding layer, and the fifth part is electrically connected with the grounding layer. The first part, the second part, and the third part constitute the first grounding member, and the first part, the fourth part, and the fifth part constitute the second grounding member.

In an implementation, the second part keeps orthogonal to the fourth part, the third part keeps parallel to the fifth part, the second part keeps orthogonal to one of the first feeding member and the second feeding member, and fourth part keeps orthogonal to the other one of the first feeding member and the second feeding member.

In an implementation, each of the second part and fourth part is a long-strip patch, a square patch, or a circular patch. The second part has a first electrical connection end and a second electrical connection end disposed opposite to the first electrical connection end, and the fourth part has a third electrical connection end and a fourth electrical connection end disposed opposite to the third electrical connection end. Each of the first electrical connection end and the third electrical connection end is electrically connected with the first part, the second electrical connection end is electrically connected with the third part, and the fourth electrical connection end is electrically connected with the fifth part.

In an implementation, the second part defines a first through hole, the fourth part defines a second through hole, the first through hole avoids the first electrical connection end and the second electrical connection end, and the second through hole avoids the third electrical connection end and the fourth electrical connection end.

In an implementation, a size of the grounding layer is λ×λ, and a distance between the patch array and the grounding layer is λ/4, where × is a wavelength of a radio frequency (RF) signal received and transmitted by the antenna module.

In an implementation, a projection of the patch array on the dielectric substrate is located within a range of a projection of the grounding layer on the dielectric substrate.

An electronic device is also provided in the present disclosure. The electronic device includes a main board and the antenna module which is illustrated in any of the above implementations. The main board includes an excitation source, the antenna module is electrically connected with the excitation source, and the excitation source is configured to provide current signals for the antenna module.

In an implementation, the electronic device further includes a battery cover. The battery cover is spaced apart from the antenna module, the battery cover is at least partially located within a radiation direction range of receiving and transmitting a RF signal by the antenna module, the antenna module is configured to receive and transmit the RF signal through the battery cover under control of the main board, and the battery cover is made of any one or more of: plastic, glass, sapphire, and ceramic.

In an implementation, the main board is located at a side of the antenna module away from the battery cover, and the main board is configured to reflect the RF signal transmitted by the antenna module toward a side where the battery cover is located.

In an implementation, the battery cover includes a back plate and a side plate surrounding the back plate, and the side plate is located within the radiation direction range of receiving and transmitting the RF signal by the antenna module.

In an implementation, the battery cover includes a back plate and a side plate surrounding the back plate, and the back plate is located within the radiation direction range of receiving and transmitting the RF signal by the antenna module.

In an implementation, the battery cover includes a back plate and a side plate surrounding the back plate, the antenna module includes a first module and a second module, the first module has a radiation surface facing the back plate, and the second module has a radiation surface facing the side plate.

In an implementation, the electronic device further includes a screen. The screen is spaced apart from the antenna module, and the screen is at least partially located within the radiation direction range of receiving and transmitting the RF signal by the antenna module.

Technical solutions of implementations of the present disclosure will be described clearly and completely with reference to accompanying drawings in the implementations of the present disclosure. Apparently, the implementations described herein are merely some implementations, rather than all implementations, of the present disclosure. Based on the implementations of the present disclosure, all other implementations obtained by those of ordinary skill in the art without creative effort shall fall within the protection scope of the disclosure. It should be noted that words “first”, “second”, and other words appearing in the present disclosure are only used to distinguish names of components, and do not represent the number or order of occurrence.

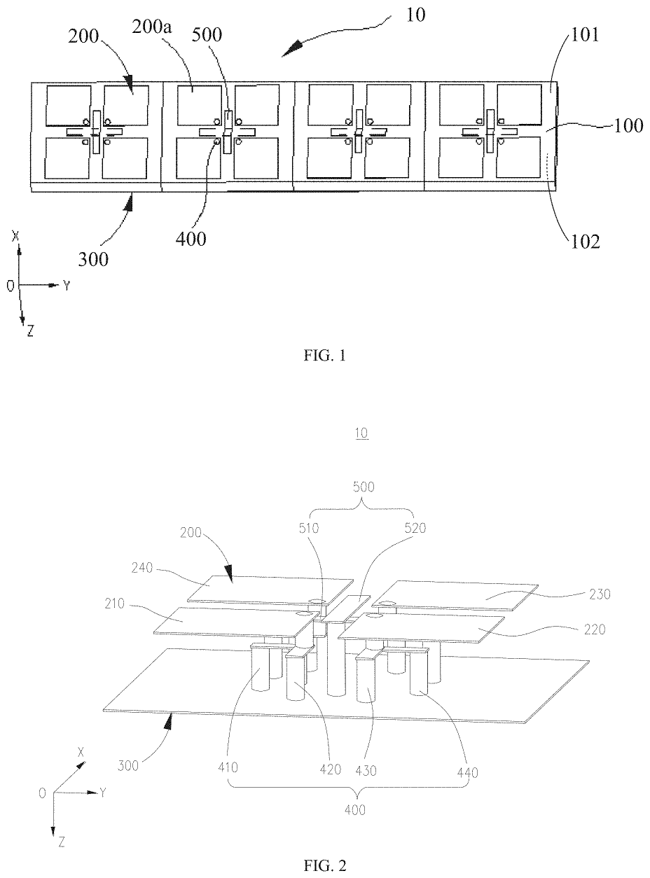

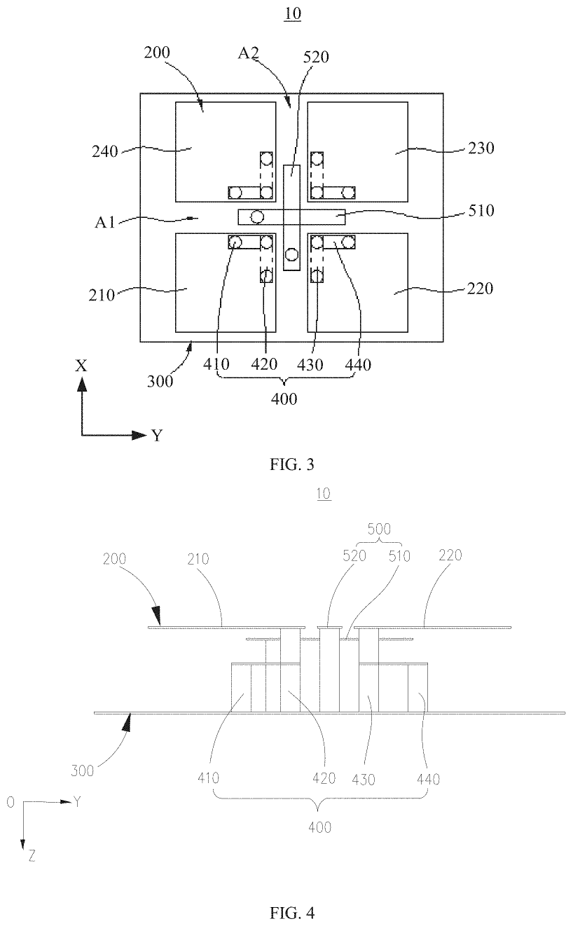

Reference can be made to FIG. 1, FIG. 2, FIG. 3, and FIG. 4 together, in order to observe an inner structure of an antenna module clearly, an example of only one antenna module is taken for illustration in FIG. 2, FIG. 3, and FIG. 4, and a dielectric substrate 100 is omitted. An antenna module 10 provided in implementations of the present disclosure includes a dielectric substrate 100, a patch array 200, a grounding layer 300, a grounding portion 400, and a feeding portion 500. The patch array 200 is carried on a first surface 101 of the dielectric substrate 100, where the patch array 200 defines a first slot A1 and a second slot A2 intersected with the first slot A1. The grounding layer 300 carried on a second surface 102 of the dielectric substrate 100, where the second surface 102 is opposite to the first surface 101. The grounding portion 400 is electrically connected with the patch array 200 and the grounding layer 300. The feeding portion 500 includes a first feeding member 510 and a second feeding member 520 disposed in an intersected and insulated manner. The “intersected” means that a projection of the first feeding member 510 on the dielectric substrate 100 is intersected with a projection of the second feeding member 520 on the dielectric substrate 100. The projection of the first feeding member 510 on the dielectric substrate 100 and a projection of the first slot A1 on the dielectric substrate 100 are at least partially overlapped, and the projection of the second feeding member 520 on the dielectric substrate 100 and a projection of the second slot A2 on the dielectric substrate 100 are at least partially overlapped. The first feeding member 510 and the second feeding member 520 are respectively configured to feed current signals, to excite the patch array 200 and the grounding portion 400 to resonate in corresponding frequency bands. Specifically, the first feeding member 510 and the second feeding member 520 can respectively feed different current signals, to excite the patch array 200 and the grounding portion 400 to resonate in different frequency bands, which can realize dual-frequency dual polarization. The first feeding member 510 and the second feeding member 520 can feed the same current signal, to excite the patch array 200 and the grounding portion 400 to resonate in the same frequency band, which can enhance signal strength.

The antenna module 10 may be a mmWave module. The antenna module 10 is configured to receive and transmit a mmWave RF signal of a preset frequency band. The antenna module 10 may be formed by performing a high density interconnector (HDI) process or an integrated circuit (IC) substrate process. The dielectric substrate 100 is formed by pressing multiple layers of dielectric plates. The patch array 200, the grounding layer 300, the grounding portion 400, and the feeding portion 500 are all carried on the dielectric substrate 100. The grounding layer 300 is spaced apart from the patch array 200. The grounding portion 400 is connected between the grounding layer 300 and the patch array 200. The grounding portion 400 has a bending structure, thus transmission paths of currents can be extended, which in turn improves a bandwidth of the RF signal. Meanwhile, a thickness of the antenna module 10 can be reduced.

The patch array 200 includes multiple patch units 200a, and each patch unit 200a constitutes an antenna radiator. The feeding portion 500 extends to a position close to the patch array 200, and the feeding portion 500 extends to a position close to the grounding portion 400, which facilitates current signals on the feeding portion 500 being coupled to the patch array 200 and the grounding portion 400. Each of the multiple patch units 200a may be rectangular, circular, triangular, pentagonal, hexagonal, etc. It can be understood that the patch unit 200a may define a through hole, and the through hole may be a square hole, a circular hole, a cross hole, or other forms of holes. In an implementation, the patch array 200 includes a first radiator 210 and a second radiator 220, each of the first radiator 210 and the second radiator 220 is a metal patch, and the first radiator 210 and the second radiator 220 are disposed in mirror symmetry. In this case, when the current signals on the feeding portion 500 are coupled to the first radiator 210 and the second radiator 220, flow directions of currents in the first radiator 210 and the second radiator 220 can be relatively uniform, and radiation performance of the antenna module 10 can be relatively stable.

Specifically, the first feeding member 510 is configured to feed a first current signal, the first current signal is coupled to the patch array 200 to excite the patch array 200 to resonate in a first frequency band, and the first current signal is coupled to the grounding portion 400 to excite the grounding portion 400 to resonate in a second frequency band, where the first frequency band may be the same as or different from the second frequency band. The second feeding member 520 is configured to feed a second current signal, the second current signal is coupled to the patch array 200 to excite the patch array 200 to resonate in a third frequency band, and the second current signal is coupled to the grounding portion 400 to excite the grounding portion 400 to resonate in a fourth frequency band, where the third frequency band may be the same as or different from the fourth frequency band. In an implementation, when the first frequency band is different from the second frequency band and the third frequency band is different from the fourth frequency band, the first frequency band may be a high-frequency frequency band and the second frequency band may be a low-frequency frequency band, and the third frequency band may be the high-frequency frequency band and the fourth frequency band may be the low-frequency frequency band. As such, the antenna module 10 can realize receiving and transmitting of RF signals of multi-frequency bands. Furthermore, a minimum value of the first frequency band is greater than a maximum value of the second frequency band, a minimum value of the third frequency band is greater than a maximum value of the fourth frequency band, and the first frequency band, the second frequency band, the third frequency band, and the fourth frequency band together constitute a preset frequency band, the preset frequency band at least including a full frequency band of 3GPP mmWave.

According to the protocol of the 3GPP technical specification (TS) 38.101, two frequency bands are mainly used in the 5th generation (5G) mobile communication technology: a frequency range 1 (FR1) band and a frequency range 2 (FR2) band. The FR1 band has a frequency range of 450 megahertz (MHz)˜6 gigahertz (GHz), and is also known as the sub-6 GHz frequency band; the FR2 band has a frequency range of 24.25 Ghz˜52.6 GHz, and is generally known as the mmWave frequency band. The 3GPP Release 15 specifies that present 5G mmWave frequency bands include: n257 (26.5˜29.5 GHz), n258 (24.25˜27.5 GHz), n261 (27.5˜28.35 GHz), and n260 (37˜40 GHz). The first frequency band may be the mmWave frequency band, in this case, the second frequency band may be the sub-6 GHz frequency band. Each of the first frequency band and the second frequency band may also be the mmWave frequency band, where the first frequency band is a high-frequency mmWave frequency band, and the second frequency band is a low-frequency mmWave frequency band. Likewise, the third frequency band may be the mmWave frequency band, in this case, the fourth frequency band may be the sub-6 GHz frequency band. Each of the third frequency band and the fourth frequency band may also be the mmWave frequency band, where the third frequency band is the high-frequency mmWave frequency band, and the fourth frequency band is the low-frequency mmWave frequency band.

Furthermore, the first feeding member 510 is insulated from the second feeding member 520, and the projection of the first feeding member 510 on the dielectric substrate 100 is intersected with the projection of the second feeding member 520 on the dielectric substrate 100. When the first feeding member 510 keeps orthogonal to the second feeding member 520, a direction of a current in the first feeding member 510 keeps orthogonal to a direction of a current in the second feeding member 520, in this case, the antenna module 10 has a dual-polarization characteristic.

In an implementation, a projection of the patch array 200 on the dielectric substrate 100 is located within a range of a projection of the grounding layer 300 on the dielectric substrate 100. A size of the grounding layer 300 is λ×λ, and a distance between the patch array 200 and the grounding layer 300 is λ/4, where λ is a wavelength of a RF signal received and transmitted by the antenna module 10.

Specifically, λ is a wavelength corresponding to a fixed frequency, when the antenna module 10 operates in the first frequency band and the second frequency band, the fixed frequency is an intermediate value of a center frequency of the first frequency band and a center frequency of the second frequency band. When the antenna module 10 operates in the third frequency band the fourth frequency, the fixed frequency is an intermediate value of a center frequency of the third frequency band and a center frequency of the fourth frequency band. When the size of the grounding layer 300 satisfies λ×λ, and the distance between the patch array 200 and the grounding layer 300 satisfies λ/4, the antenna module 10 can reach a relatively high radiation performance. In other words, an operating frequency of the antenna module 10 is closely related to a structural dimension of the antenna module 10, different structural dimensions of the antenna module 10 can affect the operating frequency of the antenna module 10, and can also affect the radiation performance of the antenna module 10.

The grounding portion 400 includes a first grounding member 410 and a second grounding member 420, the first grounding member 410 is electrically connected with the first radiator 210 and the grounding layer 300, and the second grounding member 420 is electrically connected with the first radiator 210 and the grounding layer 300. The grounding portion 400 further includes a third grounding member 430 and a fourth grounding member 440, the third grounding member 430 is electrically connected with the second radiator 220 and the grounding layer 300, and the fourth grounding member 440 is electrically connected with the second radiator 220 and the grounding layer 300.

In an implementation, the first grounding member 410 and the second grounding member 420 are connected and at least share a partial structure. The first current signal fed by the first feeding member 510 can be transmitted to the grounding layer 300 through the first radiator 210 and the first grounding member 410. The second current signal fed by the second feeding member 520 can be transmitted to the grounding layer 300 through the first radiator 210 and the second grounding member 420. In other words, both the first grounding member 410 and the second grounding member 420 are electrically connected with a same radiator, such that at least two loops are formed between one radiator and the grounding layer 300, which helps to improve stability of the antenna module 10. Likewise, both the third grounding member 430 and the fourth grounding member 440 are also electrically connected with a same radiator, such that at least two loops are formed between one radiator and the grounding layer 300, which helps to improve the stability of the antenna module 10.

In another implementation, the first grounding member 410 is spaced apart from the second grounding member 420, in other words, there is no overlap part between the first grounding member 410 and the second grounding member 420, the first grounding member 410 and the second grounding member 420 are configured to transmit current signals separately, therefore, it can be ensured that there is no mutual interference between the current signals. Likewise, the third grounding member 430 is spaced apart from the fourth grounding member 440, in other words, there is no overlap part between the third grounding member 430 and the fourth grounding member 440, the third grounding member 430 and the fourth grounding member 440 are configured to transmit current signals separately, therefore, it can be ensured that there is no mutual interference between the current signals.

The antenna module 10 further includes a third radiator 230 and a fourth radiator 240, the first radiator 210, the second radiator 220, the third radiator 230, and the fourth radiator 240 are all spaced apart to define the first slot A1 and the second slot A2 intersected with each another.

Specifically, each of the first radiator 210, the second radiator 220, the third radiator 230, and the fourth radiator 240 is a metal patch, and the patch array 200 has a mirror symmetry structure. The first radiator 210, the second radiator 220, the third radiator 230, and the fourth radiator 240 constitute a mesh structure. The feeding portion 500 is disposed corresponding to slots between the first radiator 210, the second radiator 220, the third radiator 230 and the fourth radiator 240. The feeding portion 500 is configured to transmit currents to the first radiator 210, the second radiator 220, the third radiator 230, and the fourth radiator 240 in a coupled feeding manner, which makes the first radiator 210, the second radiator 220, the third radiator 230, and the fourth radiator 240 generate resonance. In this case, when the current signals on the feeding portion 500 are coupled to the first radiator 210, the second radiator 220, the third radiator 230, and the fourth radiator 240, flow directions of the currents in the first radiator 210, the second radiator 220, the third radiator 230, and the fourth radiator 240 can be relatively uniform, and in turn the radiation performance of the antenna module 10 can be relatively stable.

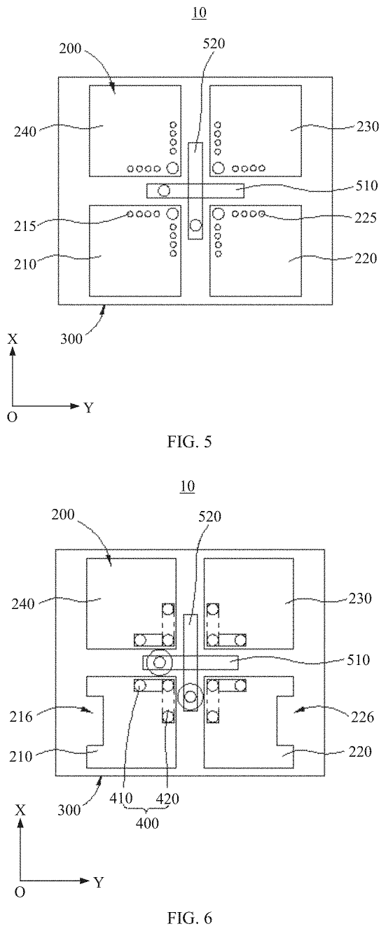

Reference can continue to be made to FIG. 5, the first radiator 210 defines multiple first metallization via holes 215 arranged in an array at an edge part of the first radiator 210 close to the first feeding member 510, and the second radiator 220 defines multiple second metallization via holes 225 arranged in an array at an edge part of the second radiator 220 close to the second feeding member 520.

Distances between any two adjacent first metallization via holes 215 keep consistent, and distance between any two adjacent second metallization via holes 225 keep consistent. The first metallization via holes 215 and the second metallization via holes 225 are used to isolate the first radiator 210 and the second radiator 220, so as to prevent mutual interference between the first radiator 210 and the second radiator 220.

In an implementation, one first metallization via hole 215 is provided corresponding to one grounding member, and one second metallization via hole 225 is provided corresponding to one grounding member. The grounding members are electrically connected with the first metallization via holes 215 to electrically connect the first radiator 210 and the grounding layer 300. The grounding members are electrically connected with the second metallization via holes 225 to electrically connect the second radiator 220 and the grounding layer 300. Multiple grounding members generate synchronous resonance to generate a RF signal of the second frequency band.

Reference can continue to be made to FIG. 6, the first radiator 210 can also define a first accommodating groove 216 at an edge part of the first radiator 210 away from the second feeding member 520, the second radiator 220 defines a second accommodating groove 226 at an edge part of the second radiator 220 away from the second feeding member 520, and an opening direction of the first accommodating groove 216 is opposite to an opening direction of the second accommodating groove 226.

The first accommodating groove 216 may be a rectangular groove or a curved groove. The second accommodating groove 226 may be a rectangular groove or a curved groove. The first accommodating groove 216 is located at the edge part of the first radiator 210 away from the feeding portion 500, and the first accommodating groove 216 penetrates through the edge part of the first radiator 210; and the second accommodating groove 226 is located at the edge part of the second radiator 220 away from the feeding portion 500, and the second accommodating groove 226 penetrates through the edge part of the second radiator 220. The opening direction of the first accommodating groove 216 is opposite to the opening direction of the second accommodating groove 226, and a size of the first accommodating groove 216 keeps consistent with a size of the second accommodating groove 226, such that when the current signals on the feeding portion 500 are coupled to the first radiator 210 and the second radiator 220, distribution of coupled current signals on the first radiator 210 and the second radiator 220 can be relatively uniform, thereby helping to improve the radiation performance of the antenna module 10.

Reference can continue to be made to FIG. 7, the first radiator 210 can also define a first curved groove 217 at a middle part of the first radiator 210 away from the first feeding member 510, and the second radiator 220 defines a second curved groove 227 at a middle part of the second radiator 220 away from the second feeding member 520, and an opening direction of the first curved groove 217 is opposite to an opening direction of the second curved groove 227.

A curved groove may be a C-shaped groove, a U-shaped groove, or a broken-line shaped groove, etc. The first curved groove 217 is located at the middle part of the first radiator 210, the second curved groove 227 is located at the middle part of the second radiator 220, and the opening direction of the first curved groove 217 is opposite to the opening direction of the second curved groove 227. Since the first curve groove 217 is located at the middle part of the first radiator 210 and the second curved groove 227 is located at the middle part of the second radiator 220, the current signals coupled to the first radiator 210 and the second radiator 220 by the feeding portion 500 are transmitted in ring shapes, which helps to extend the transmission paths of the currents, thereby broadening the bandwidth of the RF signal received and transmitted by the antenna module 10. The first radiator 210 and the second radiator 220 are disposed in mirror symmetry, which can ensure that performance of the first radiator 210 keeps consistent with performance of the second radiator 220, so as to make the radiation performance of the antenna module 10 relatively stable.

In the antenna module 10 provided in implementations of the present disclosure, the first grounding member 410 and the second grounding member 420 at least share a partial structural, such that the thickness of the antenna module 10 can be reduced to 0.85 mm, and the antenna module 10 has a low-profile characteristic, so as to realize miniaturization of the antenna module 10. In addition, the first feeding member 510 is insulated from the second feeding member 520, the projection of the first feeding member 510 on the dielectric substrate 100 is intersected with the projection of the second feeding member 520 on the dielectric substrate 100, the current signals are fed through the first feeding member 510 and the second feeding member 520 to excite the patch array 200 and the grounding portion 400 to generate resonance, which can realize receiving and transmitting of the RF signal of dual frequency band, and can realize dual polarization.

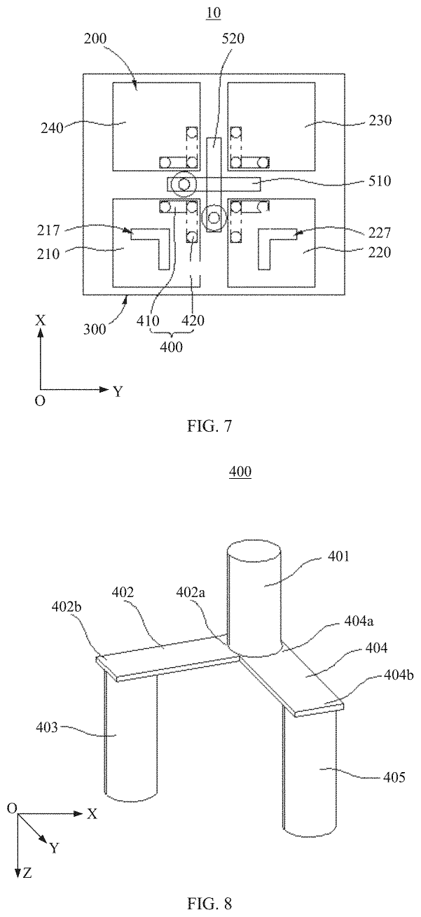

Reference can continue to be made to FIG. 8, the first grounding portion 400 has a first part 401, a second part 402, a third part 403, a fourth part 404, and a fifth part 405. The first part 401, the second part 402, and the third part 403 are connected in sequence, a first included angle is defined between the first part 401 and the second part 402, and a second included angle is defined between the second part 402 and the third part 403. The first part 401, the fourth part 404, and the fifth part 405 are connected in sequence, a third included angle is defined between the first part 401 and the fourth part 404, and a fourth included angle is defined between the fourth part 404 and the fifth part 405. The first part 401 is electrically connected with the patch array 200, the third part 403 is electrically connected with the grounding layer 300, and the fifth part 405 is electrically connected with the grounding layer 300. The first part 401, the second part 402, and the third part 403 constitute the first grounding member 410, and the first part 401, the fourth part 404, and the fifth part 405 constitute the second grounding member 420.

Specifically, the first grounding member 410 and the second ground member 420 share the first part 401. The first ground member 410 is bent in “ [symbol] ” shape, and the second ground member 420 is bent in “ [symbol] ” shape. The first part 401 is electrically connected with the patch array 200, and each of the third part 403 and the fifth part 405 is electrically connected with the grounding layer 300. When currents in the first feeding member 510 and the second feeding member 520 are coupled to the first grounding member 410 and the second grounding member 420, the transmission paths of coupled currents in the first grounding member 410 and the second grounding member 420 can be extended, and then the thickness of the antenna module 10 can be further reduced while increasing the bandwidth of the antenna module 10.

In an implementation, the second part 402 keeps orthogonal to the fourth part 404, the third part 403 keeps parallel to the fifth part 405, the second part 402 keeps orthogonal to one of the first feeding member 510 and the second feeding member 520, and the fourth part 404 keeps orthogonal to the other one of the first feeding member 510 and the second feeding member 520, which can make the antenna module have a dual polarization characteristic.

Each of the second part 402 and fourth part 404 is a long-strip patch. The second part 402 has a first electrical connection end 402a and a second electrical connection end 402b disposed opposite to the first electrical connection end 402a, and the fourth part 404 has a third electrical connection end 404a and a fourth electrical connection end 404b disposed opposite to the third electrical connection end 404a. Each of the first electrical connection end 402a and the third electrical connection end 404a is electrically connected with the first part 401, the second electrical connection end 402b is electrically connected with the third part 403, and the fourth electrical connection end 404b is electrically connected with the fifth part 405.

In an implementation, the first electrical connection end 402a and the third electrical connection end 404a are electrically connected with the same part of the first part 401. Specifically, the second part 402 has a long-strip structure and has a first end and a second end. The first end has the first electrical connection end 402a, and the second end has the second electrical connection end 402b. The first part 401 is electrically connected between the first electrical connection end 402a and the patch array 200, the third part 403 is electrically connected between the second electrical connection end 402b and the grounding layer 300. In this case, an intensity of a coupled current per unit area can be enhanced to facilitate adjustment of a frequency band of a RF signal received and transmitted by the grounding portion 400, which makes the grounding portion 400 resonate in the preset frequency band.

Furthermore, the first part 401, the third part 403, the fifth part 405 may also have the long-strip structure or a columnar structure. The first part 401, the second part 402, and the third part 403 are connected, the first included angle is defined between the first part 401 and the second part 402, and the second included angle is defined between the second part 402 and the third part 403, and the first part 401, the fourth part 404, and the fifth part 405 are connected, the third included angle is defined between the first part 401 and the fourth part 404, and the fourth included angle is defined between the fourth part 404 and the fifth part 405, such that the transmission paths of the coupled currents coupled from the feeding portion 500 to the grounding portion 400 can be extended, thereby improving the bandwidth of the RF signal received and transmitted by the antenna module 10 and reducing the thickness of the antenna module 10.

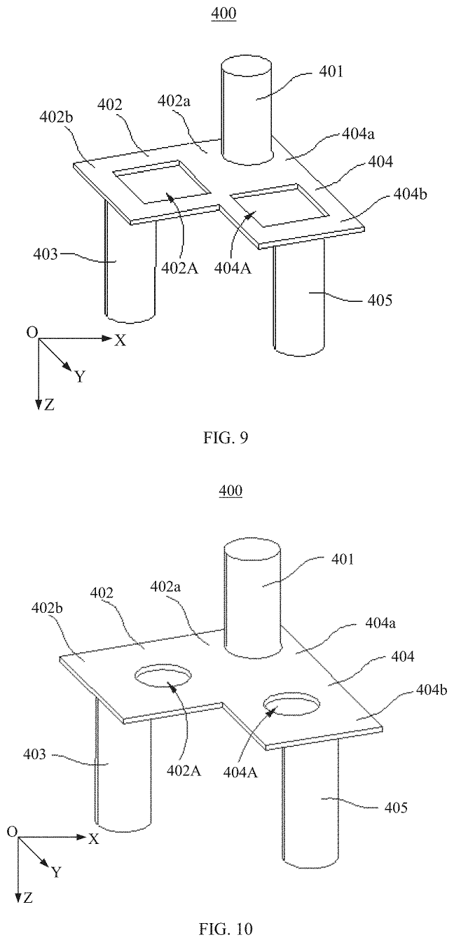

Reference can continue to be made to FIG. 9 and FIG. 10, and each of the second part 402 and the fourth part 404 is a square patch or a circular patch. The second part 402 has a first electrical connection end 402a and a second electrical connection end 402b spaced apart from the first electrical connection end 402a, the fourth part 404 has a third electrical connection end 404a and a fourth electrical connection end 404b spaced apart from the third electrical connection end 404a. In addition, each of the first electrical connection end 402a and the third electrical connection end 404a is electrically connected with the first part 401, the second electrical connection end 402b is electrically connected with the third part 403, and the fourth electrical connection end 404b is electrically connected with the fifth part 405.

Specifically, in an implementation, the second part 402 may be a rectangular patch or the circular patch, or may be an oblong patch or a square patch. The second part 402 has the third electrical connection end 404a and the fourth electrical connection end 404b spaced apart from the third electrical connection end 404a. The first part 401 is electrically connected between the third electrical connection end 404a and the patch array 200, and the third part 403 is electrically connected between the fourth electrical connection end 404b and the grounding layer 300. In this case, an area of the second part 402 can be increased, when the current signals on the feeding portion 500 are coupled to the grounding portion 400, transmission of the coupled currents can be relatively uniform by increasing grounding areas of the coupled currents, thereby making the performance of receiving and transmitting of the RF signal by the antenna module 10 relatively stable.

The second part 402 defines a first through hole 402A, the fourth part 404 defines a second through hole 404A, the first through hole 402A avoids the first electrical connection end 402a and the second electrical connection end 402b, and the second through hole 404A avoids the third electrical connection end 404a and the fourth electrical connection end 404b. The first through hole 402A and the second through hole 404A may be circular holes, square holes, cross holes, or other forms of holes.

Specifically, in this implementation, the second part 402 defines one or more through holes. When the current signals on the feeding portion 500 are coupled to the grounding portion 400, coupled currents in the second part 402 can be transmitted along multiple transmission paths, such that the transmission paths of the coupled currents can be extended, thereby improving the bandwidth of the RF signal received and transmitted by the antenna module 10. The third electrical connection end 404a and the fourth electrical connection end 404b are disposed to avoid the one or more through holes, which can keep an electrical connection relationship between the grounding portion 400 and the patch array 200 and an electrical connection relationship between the grounding portion 400 and the grounding layer 300 stable.

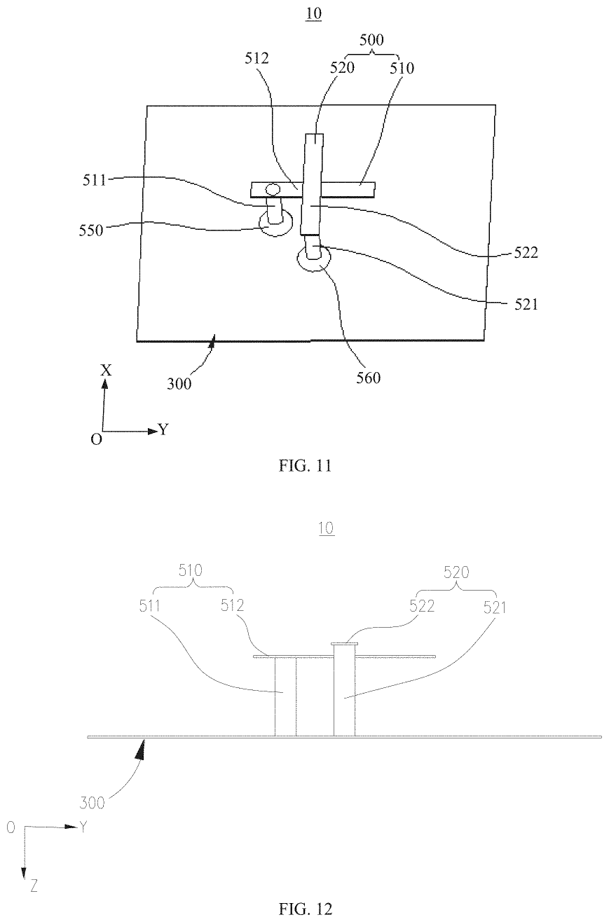

Reference can continue to be made to FIG. 11 and FIG. 12, and the antenna module 10 includes a first feeding port 550 and a second feeding port 560. The first feeding member 510 has a first section 511 and a second section 512 connected with the first section 511, a first included angle is defined between the first section 511 and the second section 512, the first section 511 is electrically connected with the first feeding port 550, the first section 511 is disposed close to the grounding portion 400, and the second section 512 is disposed close to the patch array 200. The second feeding member 520 has a third section 521 and a fourth section 522 connected with the third section 521, a second included angle is defined between the third section 521 and the fourth section 522, the third section 521 is electrically connected with the second feeding port 560, the third section 521 is disposed close to the grounding portion 400, and the fourth section 522 is disposed close to the patch array 200. The second section 512 keeps orthogonal to the fourth section 522, and a polarization direction of the patch array 200 keeps orthogonal to a polarization direction of the grounding portion 400.

In this implementation, the first feeding member 510 is bent in L shape, and the second feeding member 520 is also bent in L shape. The first section 511 is parallel to the third section 521, and the second section 512 and the fourth section 522 are disposed in the intersected and insulated manner. When the second section 512 keeps orthogonal to the fourth section 522, the antenna module 10 can realize the dual polarization characteristic. Furthermore, the first section 511 is perpendicular to the grounding layer 300, the third section 521 is perpendicular to the grounding layer 300, the first section 511 keeps perpendicular to the second section 512, and the third section 521 keeps perpendicular to the fourth section 522.

Furthermore, the patch array 200 and any one of the second section 512 and the fourth section 522 are disposed on the same layer. In an implementation, the second section 512 and the patch array 200 are disposed on the same layer, the fourth section 522 and the second section 512 are disposed in an intersected and spaced manner, which facilitates a current in the second section 512 being coupled to the patch array 200. In another implementation, the fourth section 522 and the patch array 200 are disposed on the same layer, the second section 512 and the fourth section 522 are disposed in the intersected and spaced manner, which facilitates a current in the fourth section 522 being coupled to the patch array 200.

In another implementation, the second section 512 and the fourth section 522 are located on different layers respectively, and the second section 512 is spaced apart from the fourth section 522.

Specifically, in this implementation, the second section 512 is spaced apart from the fourth section 522 in a thickness direction of the antenna module 10, the second section 512 and the fourth section 522 are located on different layers of the dielectric substrate 100 respectively, and when the second section 512 is perpendicular to the fourth section 522, the antenna module 10 can have the dual polarization characteristic.

Reference can continue to be made to FIG. 13, in yet another implementation, the second section 512 has a first connection portion 512a, a bending portion 512b, and a second connection portion 512c which are connected in sequence, the first connection portion 512a is connected with the first section 511, the first connection portion 512a, the second connection portion 512c, and the fourth section 522 are disposed on the same layer, and the bending portion 512b avoids the fourth section 522.

In this implementation, the second section 512 has a partial structure spanning from a surface of the fourth section 522, and the second section 512 and the fourth section 522 are disposed in the intersected and insulated manner. The second section 512 has the first connection portion 512a, the bending portion 512b, and the second connection portion 512c which are connected. The bending portion 512b is disposed corresponding to a partial structure of the fourth section 522, and the bending portion 512b spans the surface of the fourth section 522, such that the first current signal fed by the first feeding port 550 will not interfere with the second current signal fed by the second feeding port 560, which can make the radiation performance of the antenna module 10 relatively stable.

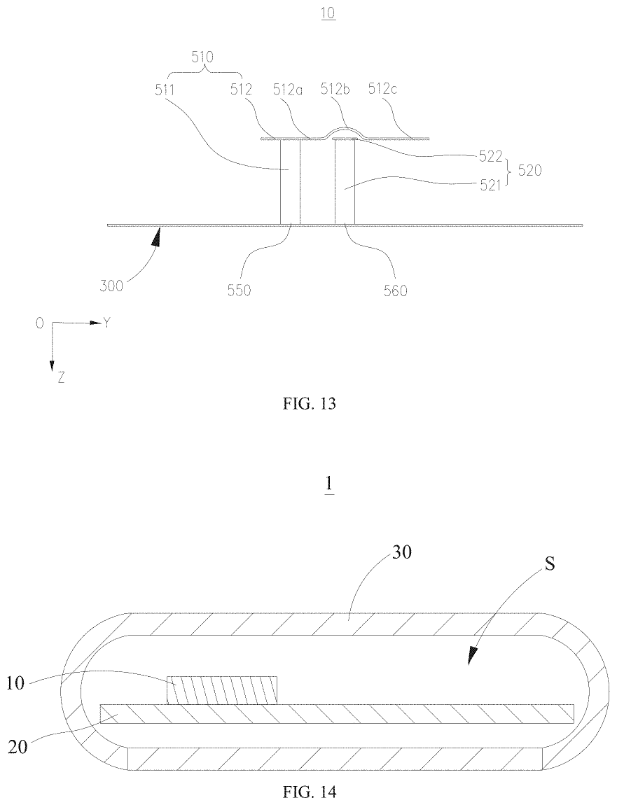

Reference can continue to be made to FIG. 14, and an electronic device 1 is also provided in implementations of the present disclosure. The electronic device 1 includes a main board 20 and the antenna module 10 which is provided in any of the above implementations. The antenna module 10 is electrically connected with the main board 20, and the antenna module 10 is configured to receive and transmit the RF signal under control of the main board 20.

Specifically, the main board 20 includes an excitation source, the antenna module is electrically connected with the excitation source, and the excitation source is configured to provide current signals for the antenna module 10.

The electronic device 1 may be any device with a communication function, for example, a tablet computer, a mobile phone, an e-reader, a remote control, a personal computer (PC), a laptop, an in-vehicle device, a network TV, a wearable device, and other smart devices with the communication function.

The main board 20 may be a printed circuit board (PCB) of the electronic device 1. The main board 20 is electrically connected with the antenna module 10 and is provided with an excitation source. The excitation source is configured to generate an excitation signal, and the excitation signal is used to control the antenna module 10 to receive and transmit RF signal of the first frequency band, the second frequency band, the third frequency band, and the fourth frequency band.

Specifically, when the feeding portion 500 feeds the first current signal, the patch array 200 resonates in the first frequency band, the grounding portion 400 resonates in the second frequency band, in other words, the antenna module 10 operates in the first frequency band and the second frequency band, in this case, the excitation signal is used to control the antenna module 10 to receive and transmit a RF signal of the first frequency band and the second frequency band. When the feeding portion 500 feeds the second current signal, the patch array 200 resonates in the third frequency band, the grounding portion 400 resonates in the fourth frequency band, in other words, the antenna module 10 operates in the third frequency band and fourth frequency band, in this case, the excitation signal is used to control the antenna module 10 to receive and transmit a RF signal of the third frequency band and the fourth frequency band.

In the antenna module 10 provided in implementations of the present disclosure, the first grounding member 410 and the second grounding member 420 at least share the partial structural, such that the thickness of the antenna module 10 can be reduced to 0.85 mm, and the antenna module 10 has the low-profile characteristic, so as to realize miniaturization of the antenna module 10. In addition, the first feeding member 510 is insulated from the second feeding member 520, the projection of the first feeding member 510 on the dielectric substrate 100 is intersected with the projection of the second feeding member 520 on the dielectric substrate 100, the current signals are fed through the first feeding member 510 and the second feeding member 520 to excite the patch array 200 and the grounding portion 400 to generate resonance, which can realize receiving and transmitting of the RF signal of dual frequency band, and can realize the dual polarization.

The electronic device 1 further includes a battery cover 30. The battery cover 30 is spaced apart from the antenna module 10, and the battery cover 30 is at least partially located within a radiation direction range of receiving and transmitting the RF signal by the antenna module 10. The antenna module 10 is configured to receive and transmit the RF signal under control of the main board 20. The battery cover 30 is made of any one or more of: plastic, glass, sapphire, and ceramic.

Specifically, in a structural arrangement of the electronic device 1, the battery cover 30 is at least partially located within the radiation direction range of receiving and transmitting the RF signal by the antenna module 10, therefore, the battery cover 30 can also have an impact on a radiation characteristic of the antenna module 10. Therefore, the RF signal received and transmitted by the antenna module 10 can be transmitted through the battery cover 30, which can make the antenna module 10 have stable radiation performance in the structural arrangement of the electronic device 1. In other words, the battery cover 30 will not block transmission of the RF signal, and the battery cover 30 may be made of any one or any combination of: plastic, glass, sapphire, and ceramic.

Furthermore, the main board 20 is located at a side of the antenna module 10 away from the battery cover 30, and the main board 20 is configured to reflect the RF signal transmitted by the antenna module 10 toward a side where the battery cover 30 is located.

The main board 20 is spaced apart from the battery cover 30, the battery cover 30 defines an accommodating space S, and the main board 20 is located in the accommodating space S. The antenna module 10 is electrically connected with the main board 20, the main board 20 is at least partially configured to reflect the RF signal of the first frequency band and the second frequency band transmitted by the antenna module 10, such that a reflected RF signal of the first frequency band and the second frequency band is radiated to free space through the battery cover 30. The main board 20 is also configured to reflect RF signal of the first frequency band and the second frequency band radiated from the free space through the battery cover 30 to the antenna module 10 toward a radiation surface of the antenna module 10.

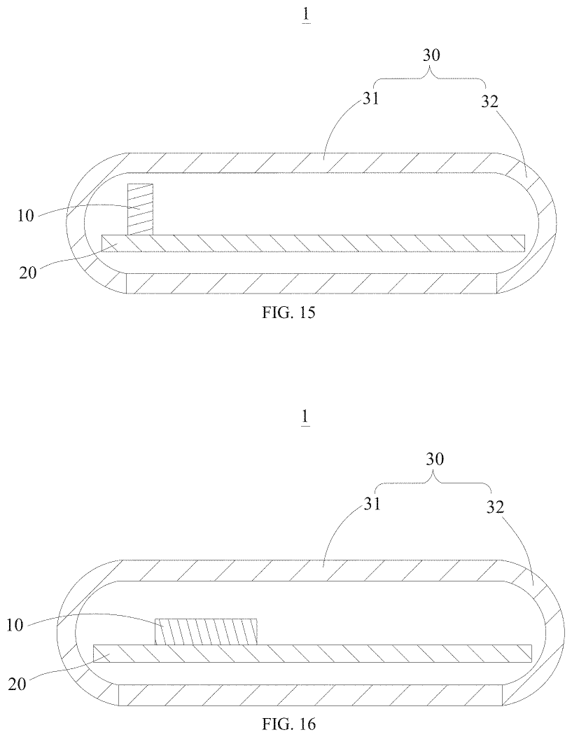

Reference can continue to be made to FIG. 15, the battery cover 30 includes a back plate 31 and a side plate 32 surrounding the back plate 31, and the side plate 32 is located within the radiation direction range of receiving and transmitting the RF signal by the antenna module 10.

Specifically, when a radiation direction of the antenna module 10 faces the side plate 32 of the battery cover 30, the side plate 32 can be adopted to perform the spatial impedance matching on the RF signal received and transmitted by the antenna module 10, in this case, the structural arrangement of the antenna module 10 in a whole device environment of the electronic device 1 is fully considered, as such, radiation effect of the antenna module 10 in the whole device environment can be ensured.

Reference can continue to be made to FIG. 16, the battery cover 30 includes a back plate 31 and a side plate 32 surrounding the back plate 31, and the back plate 31 is located within the radiation direction range of receiving and transmitting the RF signal by the antenna module 10.

Specifically, when the antenna module 10 faces the back plate 31 of the battery cover 30, the back plate 31 can be adopted to perform the spatial impedance matching on the RF signal received and transmitted by the antenna module 10, in this case, the structural arrangement of the antenna module 10 in the whole device environment of the electronic device 1 is fully considered, as such, the radiation effect of the antenna module 10 in the whole device environment can be ensured.

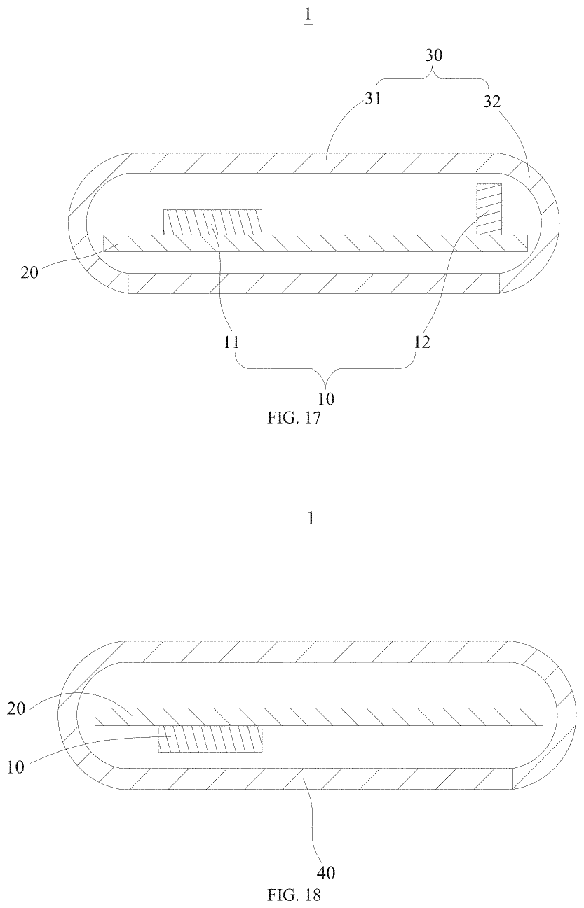

Reference can continue to be made to FIG. 17, the battery cover 30 includes a back plate 31 and a side plate 32 surrounding the back plate 31, the antenna module 10 includes a first module 11 and a second module 12, the first module 11 has a radiation surface facing the back plate 31, and the second module 12 has a radiation surface facing the side plate 32.

Specifically, in this implementation, the first module 11 and the second module 12 have different radiation directions. The first module 11 has the radiation surface facing the back plate 31, and the second module 12 has the radiation surface facing the side plate 32, such that directions of receiving and transmitting RF signal by the antenna module 10 can be diversified. When one direction of the antenna module 10 receiving and transmitting the RF signal is blocked, another direction can be adopted to receive and transmit the RF signal, such that the antenna module 10 can receive and transmit the RF signal in a relatively stable manner.

Reference can continue to be made to FIG. 18, and the electronic device 1 further includes a screen 40. The screen 40 is spaced apart from the antenna module 10, and the screen 40 is at least partially located within the radiation direction range of receiving and transmitting the RF signal by the antenna module 10.

Specifically, when the antenna module 10 faces the screen 40, the screen 40 can be adopted to perform the spatial impedance matching on the RF signal received and transmitted by the antenna module 10, in this case, the structural arrangement of the antenna module 10 in the whole device environment of the electronic device 1 is fully considered, as such, the radiation effect of the antenna module 10 in the whole device environment can be ensured.

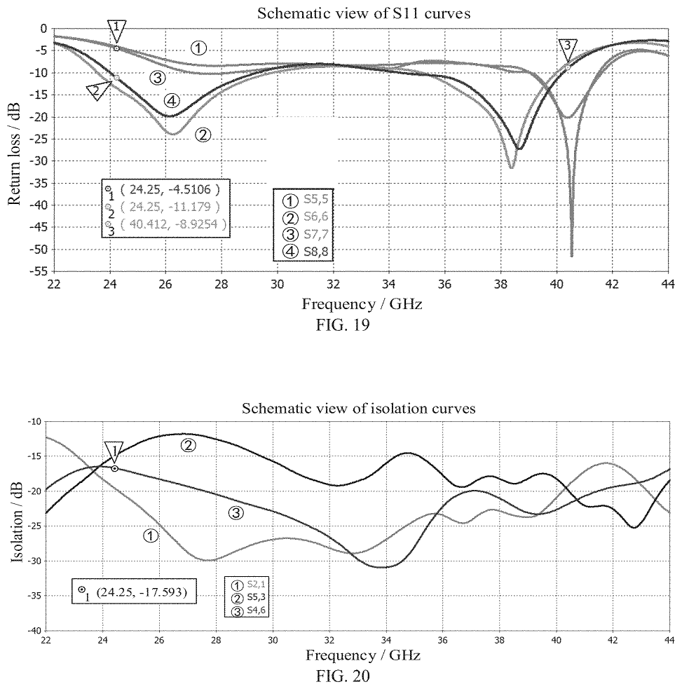

Reference can continue to be made to FIG. 19, which is a schematic view illustrating a return loss curve of each port of a 1×4 antenna array. The abscissa represents the frequency in units of GHz, and the ordinate represents the return loss in units of decibel (dB). In the present disclosure, the 1×4 antenna array has the size of 20 mm×4.2 mm×0.85 mm, and the antenna array has the thickness of 0.85 mm. In FIG. 19, four ports of the 1×4 antenna array are marked as S5,5, S6,6, S7,7, and S8,8 respectively, and corresponding return loss curves are \textcircled{1}, \textcircled{2}, \textcircled{3}, and \textcircled{4} in sequence. It can be seen that a return loss curve \textcircled{1} corresponding to port S5,5 of the antenna array basically coincides with a return loss curve \textcircled{3} corresponding to port S7,7 of the antenna array, and a return loss curve \textcircled{2} corresponding to port S6,6 of the antenna array basically coincides with a return loss curve \textcircled{4} corresponding to port S8,8 of the antenna array. At mark point 1, a frequency is 24.25 GHz, and a corresponding return loss is −4.5106 dB. At mark point 2, the frequency is 24.25 GHz, and the corresponding return loss is −11.179 dB. At mark point 3, the frequency is 40.412 GHz, and the corresponding return loss is −8.9254 dB. In other words, the 1×4 antenna array can cover a full frequency band of n257, n258, n261, and n260 mmWave. When S11≤−10 dB, a frequency band ranges from 23.6 GHz-41.6 GHz, and the 1×4 antenna array has an impedance bandwidth of 18 GHz.

Reference can continue to be made to FIG. 20, which is a schematic view illustrating isolation curves between patch-unit ports of a 1×4 antenna array. The abscissa represents the frequency in units of GHz, and the ordinate represents the return loss in units of dB. In FIG. 20, patch-unit ports in the same antenna module are marked as S2,1, S5,3, and S4,6. At mark point 1, a frequency is 24.25 GHz, and a corresponding isolation is −17.593 dB. It can be seen from FIG. 20 that the 1×4 antenna array can cover the full frequency band of n257, n258, n261, and n260 mmWave. In addition, isolation between the patch-unit ports is relatively large, which can avoid mutual interference between adjacent patch units.

Reference can continue to be made to FIG. 21, which is a radiation gain pattern illustrating an antenna module in a V-polarization direction in a frequency band of 24.25 GHz. Z axis represents a radiation direction of an antenna module, and XY axis represents a radiation angle of the antenna module relative to a main lobe. It can be seen that at a resonant frequency point of 24.25 GHz, a gain is greatest, a directivity is greatly improved, and a peak gain reaches 9.22 dB.

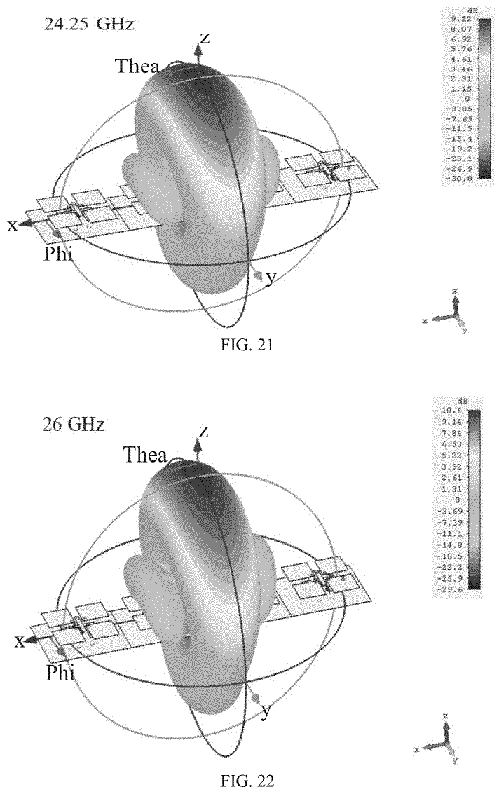

Reference can continue to be made to FIG. 22, which is a radiation gain pattern illustrating an antenna module in a V-polarization direction in a frequency band of 26 GHz. Z axis represents the radiation direction of the antenna module, and XY axis represents the radiation angle of the antenna module relative to the main lobe. It can be seen that at the resonant frequency point of 26 GHz, the gain is greatest, the directivity is greatly improved, and the peak gain reaches 10.4 dB.

Reference can continue to be made to FIG. 23, which is a radiation gain pattern illustrating an antenna module in a V-polarization direction in a frequency band of 28 GHz. Z axis represents the radiation direction of the antenna module, and XY axis represents the radiation angle of the antenna module relative to the main lobe. It can be seen that at the resonant frequency point of 28 GHz, the gain is greatest, the directivity is greatly improved, and the peak gain reaches 10.9 dB.

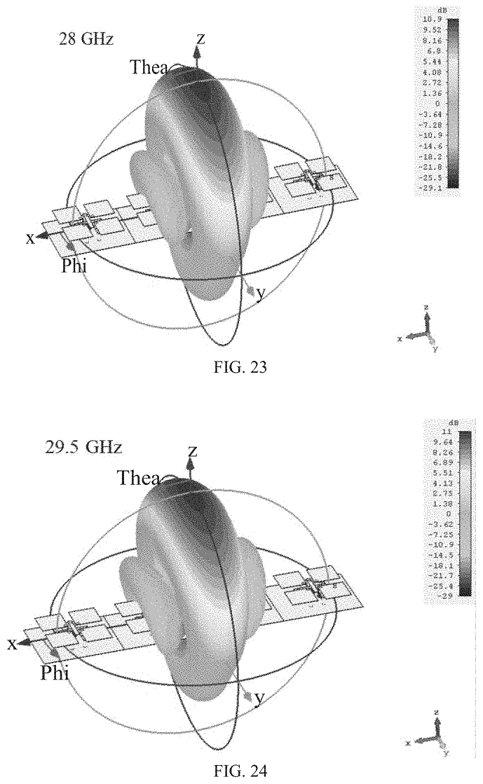

Reference can continue to be made to FIG. 24, which is a radiation gain pattern illustrating an antenna module in a V-polarization direction in a frequency band of 29.5 GHz. Z axis represents the radiation direction of the antenna module, and XY axis represents the radiation angle of the antenna module relative to the main lobe. It can be seen that at the resonant frequency point of 29.5 GHz, the gain is greatest, the directivity is greatly improved, and the peak gain reaches 11 dB.

Reference can continue to be made to FIG. 25, which is a radiation gain pattern illustrating an antenna module in a V-polarization direction in a frequency band of 37 GHz. Z axis represents the radiation direction of the antenna module, and XY axis represents the radiation angle of the antenna module relative to the main lobe. It can be seen that at the resonant frequency point of 37 GHz, the gain is greatest, the directivity is greatly improved, and the peak gain reaches 11.8 dB.

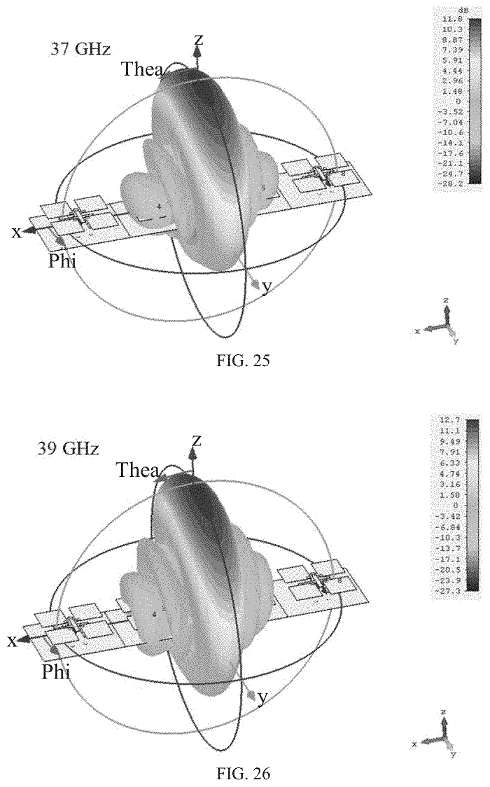

Reference can continue to be made to FIG. 26, which is a radiation gain pattern illustrating an antenna module in a V-polarization direction in a frequency band of 39 GHz. Z axis represents the radiation direction of the antenna module, and XY axis represents the radiation angle of the antenna module relative to the main lobe. It can be seen that at the resonant frequency point of 39 GHz, the gain is greatest, the directivity is greatly improved, and the peak gain reaches 12.7 dB.

Reference can continue to be made to FIG. 27, which is a radiation gain pattern illustrating an antenna module in a H-polarization direction in a frequency band of 24.25 GHz. Z axis represents the radiation direction of the antenna module, and XY axis represents the radiation angle of the antenna module relative to the main lobe. It can be seen that at the resonant frequency point of 24.25 GHz, the gain is greatest, the directivity is greatly improved, and the peak gain reaches 9.23 dB.

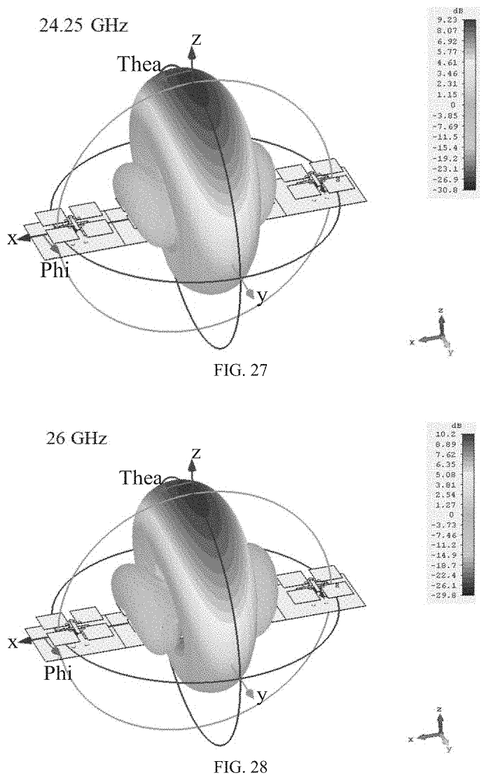

Reference can continue to be made to FIG. 28, which is a radiation gain pattern illustrating an antenna module in a H-polarization direction in a frequency band of 26 GHz. Z axis represents the radiation direction of the antenna module, and XY axis represents the radiation angle of the antenna module relative to the main lobe. It can be seen that at the resonant frequency point of 26 GHz, the gain is greatest, the directivity is greatly improved, and the peak gain reaches 10.2 dB.

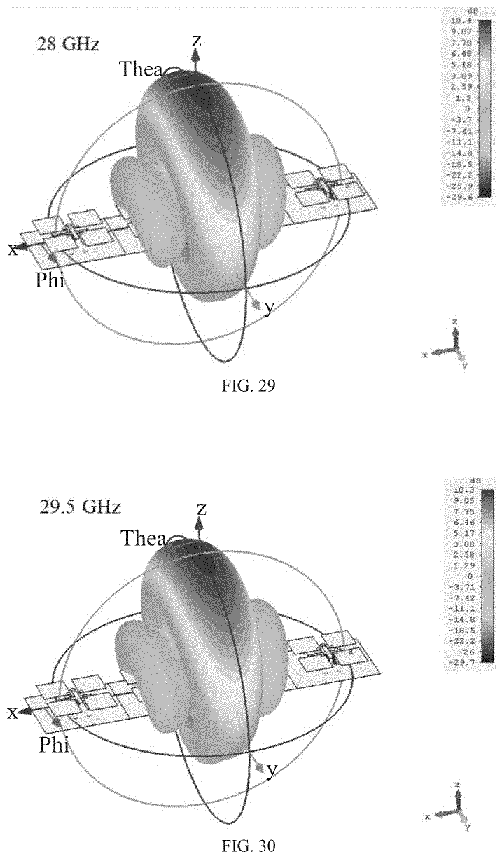

Reference can continue to be made to FIG. 29, which is a radiation gain pattern illustrating an antenna module in a H-polarization direction in a frequency band of 28 GHz. Z axis represents the radiation direction of the antenna module, and XY axis represents the radiation angle of the antenna module relative to the main lobe. It can be seen that at the resonant frequency point of 28 GHz, the gain is greatest, the directivity is greatly improved, and the peak gain reaches 10.4 dB.

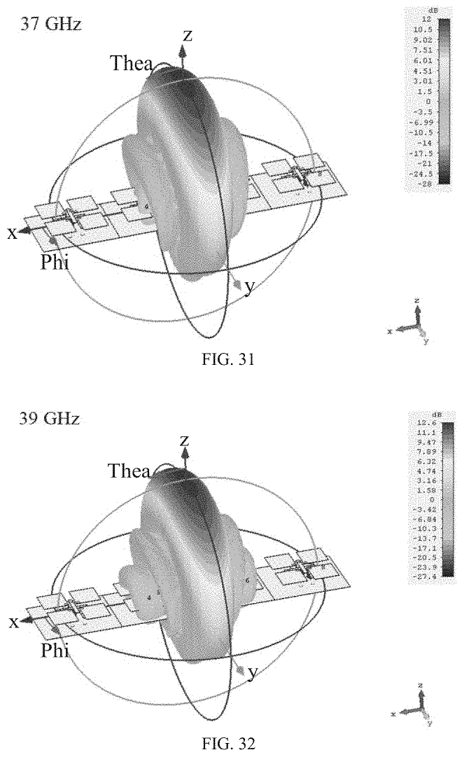

Reference can continue to be made to FIG. 30, which is a radiation gain pattern illustrating an antenna module in a H-polarization direction in a frequency band of 29.5 GHz. Z axis represents the radiation direction of the antenna module, and XY axis represents the radiation angle of the antenna module relative to the main lobe. It can be seen that at the resonant frequency point of 29.5 GHz, the gain is greatest, the directivity is greatly improved, and the peak gain reaches 10.3 dB.

Reference can continue to be made to FIG. 31, which is a radiation gain pattern illustrating an antenna module in a H-polarization direction in a frequency band of 37 GHz. Z axis represents the radiation direction of the antenna module, and XY axis represents the radiation angle of the antenna module relative to the main lobe. It can be seen that at the resonant frequency point of 37 GHz, the gain is greatest, the directivity is greatly improved, and the peak gain reaches 12 dB.

Reference can continue to be made to FIG. 32, which is a radiation gain pattern illustrating an antenna module in a H-polarization direction in a frequency band of 39 GHz. Z axis represents the radiation direction of the antenna module, and XY axis represents the radiation angle of the antenna module relative to the main lobe. It can be seen that at the resonant frequency point of 39 GHz, the gain is greatest, the directivity is greatly improved, and the peak gain reaches 12.6 dB.

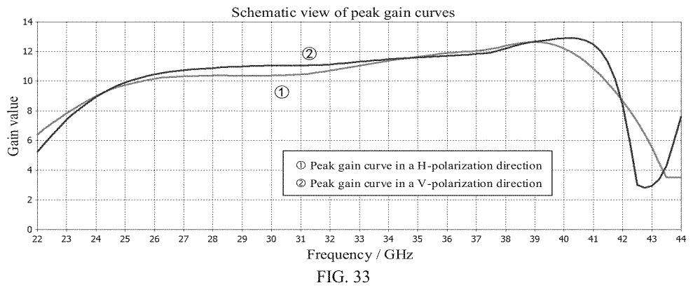

Reference can continue to be made to FIG. 33, which is a schematic view illustrating variation curves of peak gains of an antenna module in different polarization directions with frequencies. The abscissa represents the frequency in units of GHz, and the ordinate represents the peak gain. Curve \textcircled{1} represents a peak gain curve in the H-polarization direction, and curve \textcircled{2} represents a peak gain curve in the V-polarization direction. It can be seen that the 1×4 antenna array can cover the full frequency band of n257, n258, n261, and n260 mmWave, in addition, with the frequency increasing from 22 GHz to 41 GHz, the peak gain of the antenna module gradually increases, and with the frequency increasing from 41 GHz to 44 GHz, the peak gain of the antenna module gradually decreases, furthermore, it can be seen that each gain value of the antenna module is relatively large.

The above implementations in the present disclosure are described in detail. Principles and implementation manners of the present disclosure are elaborated with specific implementations herein. The above illustration of implementations is only used to help to understand methods and core ideas of the present disclosure. At the same time, for those of ordinary skill in the art, according to ideas of the present disclosure, there will be changes in specific implementation manners and application scope. In summary, contents of this specification should not be understood as limitations on the present disclosure.

What is claimed is:

1. An antenna module, comprising:
a dielectric substrate;
a patch array carried on a first surface of the dielectric substrate, wherein the patch array defines a first slot and a second slot intersected with the first slot;
a grounding layer carried on a second surface of the dielectric substrate, wherein the second surface is opposite to the first surface;
a grounding portion electrically connected with the patch array and the grounding layer; and
a feeding portion comprising a first feeding member and a second feeding member insulated from the first feeding member, wherein a projection of the first feeding member on the dielectric substrate is intersected with a projection of the second feeding member on the dielectric substrate, the projection of the first feeding member on the dielectric substrate and a projection of the first slot on the dielectric substrate are at least partially overlapped, the projection of the second feeding member on the dielectric substrate and a projection of the second slot on the dielectric substrate are at least partially overlapped, and the first feeding member and the second feeding member are respectively configured to feed current signals, to excite the patch array and the grounding portion to resonate in corresponding frequency bands.

2. The antenna module of claim 1, wherein
the first feeding member is configured to feed a first current signal, the first current signal is coupled to the patch array to excite the patch array to resonate in a first frequency band, and the first current signal is coupled to the grounding portion to excite the grounding portion to resonate in a second frequency band, the first frequency band being different from the second frequency band; and
the second feeding member is configured to feed a second current signal, the second current signal is coupled to the patch array to excite the patch array to resonate in a third frequency band, and the second current signal is coupled to the grounding portion to excite the grounding portion to resonate in a fourth frequency band, the third frequency band being different from the fourth frequency band.

3. The antenna module of claim 1, further comprising:
a first feeding port and a second feeding port, wherein
the first feeding member has a first section and a second section connected with the first section, a first included angle is defined between the first section and the second section, the first section is electrically connected with the first feeding port, the first section is disposed close to the grounding portion, and the second section is disposed close to the patch array;
the second feeding member has a third section and a fourth section connected with the third section, a second included angle is defined between the third section and the fourth section, the third section is electrically connected with the second feeding port, the third section is disposed close to the grounding portion, and the fourth section is disposed close to the patch array; and
the second section keeps orthogonal to the fourth section, and a polarization direction of the patch array keeps orthogonal to a polarization direction of the grounding portion.

4. The antenna module of claim 3, wherein the first section is perpendicular to the grounding layer, the third section is perpendicular to the grounding layer, the first section keeps perpendicular to the second section, and the third section keeps perpendicular to the fourth section.

5. The antenna module of claim 3, wherein the second section and the fourth section are located on different layers respectively, and the second section is spaced apart from the fourth section.

6. The antenna module of claim 3, wherein the second section has a first connection portion, a bending portion, and a second connection portion which are connected in sequence, the first connection portion is connected with the first section, the first connection portion, the second connection portion, and the fourth section are disposed on a same layer, and the bending portion avoids the fourth section.

7. The antenna module of claim 3, wherein the patch array and any one of the second section and the fourth section are disposed on a same layer.

8. The antenna module of claim 1, wherein
the patch array comprises a first radiator and a second radiator spaced apart from the first radiator;
the grounding portion comprises a first grounding member and a second grounding member, the first grounding member is electrically connected with the first radiator and the grounding layer, and the second grounding member is electrically connected with the first radiator and the grounding layer; and
the grounding portion further comprises a third grounding member and a fourth grounding member, the third grounding member is electrically connected with the second radiator and the grounding layer, and the fourth grounding member is electrically connected with the second radiator and the grounding layer.

9. The antenna module of claim 8, wherein
the first grounding member is connected with the second grounding member and the first grounding member and the second grounding member at least share a partial structure, or the first grounding member is spaced apart from the second grounding member; and
the third grounding member is connected with the fourth grounding member and the third grounding member and the fourth grounding member at least share a partial structure, or the third grounding member is spaced apart from the fourth grounding member.

10. The antenna module of claim 8, wherein the patch array further comprises a third radiator and a fourth radiator, the first radiator, the second radiator, the third radiator, and the fourth radiator are all spaced apart to define the first slot and the second slot intersected with each another.

11. The antenna module of claim 8, wherein the first radiator defines a plurality of first metallization via holes arranged in an array at an edge part of the first radiator close to the first feeding member, and the second radiator defines a plurality of second metallization via holes arranged in an array at an edge part of the second radiator close to the second feeding member.

12. The antenna module of claim 8, wherein the first radiator defines a first accommodating groove at an edge part of the first radiator away from the second feeding member, the second radiator defines a second accommodating groove at an edge part of the second radiator away from the second feeding member, and an opening direction of the first accommodating groove is opposite to an opening direction of the second accommodating groove.

13. The antenna module of claim 8, wherein the first radiator defines a first curved groove at a middle part of the first radiator away from the first feeding member, and the second radiator defines a second curved groove at a middle part of the second radiator away from the second feeding member, and an opening direction of the first curved groove is opposite to an opening direction of the second curved groove.

14. The antenna module of claim 8, wherein
the grounding portion has a first part, a second part, a third part, a fourth part, and fifth part;
the first part, the second part, and the third part are connected in sequence, a first included angle is defined between the first part and the second part, and a second included angle is defined between the second part and the third part;
the first part, the fourth part, and the fifth part are connected in sequence, a third included angle is defined between the first part and the fourth part, and a fourth included angle is defined between the fourth part and the fifth part;
the first part is electrically connected with the patch array, the third part is electrically connected with the grounding layer, and the fifth part is electrically connected with the grounding layer; and
the first part, the second part, and the third part constitute the first grounding member, and the first part, the fourth part, and the fifth part constitute the second grounding member.

15. The antenna module of claim 14, wherein the second part keeps orthogonal to the fourth part, the third part keeps parallel to the fifth part, the second part keeps orthogonal to one of the first feeding member and the second feeding member, and fourth part keeps orthogonal to the other one of the first feeding member and the second feeding member.

16. The antenna module of claim 14, wherein
each of the second part and fourth part is a long-strip patch, a square patch, or a circular patch;
the second part has a first electrical connection end and a second electrical connection end disposed opposite to the first electrical connection end, and the fourth part has a third electrical connection end and a fourth electrical connection end disposed opposite to the third electrical connection end; and
each of the first electrical connection end and the third electrical connection end is electrically connected with the first part, the second electrical connection end is electrically connected with the third part, and the fourth electrical connection end is electrically connected with the fifth part.

17. The antenna module of claim 16, wherein the second part defines a first through hole, the fourth part defines a second through hole, the first through hole avoids the first electrical connection end and the second electrical connection end, and the second through hole avoids the third electrical connection end and the fourth electrical connection end.

18. An electronic device, comprising:
an antenna module, comprising:
a dielectric substrate;
a patch array carried on a first surface of the dielectric substrate, wherein the patch array defines a first slot and a second slot intersected with the first slot;
a grounding layer carried on a second surface of the dielectric substrate, wherein the second surface is opposite to the first surface;
a grounding portion electrically connected with the patch array and the grounding layer; and
a feeding portion comprising a first feeding member and a second feeding member disposed in an intersected and insulated manner, wherein a projection of the first feeding member on the dielectric substrate and a projection of the first slot on the dielectric substrate are at least partially overlapped, a projection of the second feeding member on the dielectric substrate and a projection of the second slot on the dielectric substrate are at least partially overlapped, and the first feeding member and the second feeding member are respectively configured to feed current signals, to excite the patch array and the grounding portion to resonate in corresponding frequency bands;
a main board comprising an excitation source, wherein the excitation source is electrically connected with the antenna module, and the excitation source is configured to provide current signals for the antenna module.

19. The electronic device of claim 18, further comprising:
a battery cover, wherein the battery cover is spaced apart from the antenna module, the battery cover comprises a back plate and a side plate, at least one of the back plate and the side plate is at least partially located within a radiation direction range of receiving and transmitting a radio frequency (RF) signal by the antenna module, the antenna module is configured to receive and transmit the RF signal through the battery cover under control of the main board, and the battery cover is made of any one or more of: plastic, glass, sapphire, and ceramic.

20. The electronic device of claim 18, further comprising:
a screen, wherein the screen is spaced apart from the antenna module, and the screen is at least partially located within the radiation direction range of receiving and emitting the RF signal by the antenna module.
